(19) United States
(12) Patent Application Publication
(10) Pub. No.: US 2006/0184364 A1
(43) Pub. Date: Aug. 17, 2006

(54) System of influencing health-care utilizations

(76) Inventors: Anuthep Benja-Athon, New York, NY (US); Theda Benja-Athon, Port Washington, NY (US)

Correspondence Address: ANUTHEP BENJA-ATHON, M.D.;Pain Management, Acupuncture Physical Therapy, 210 E 36th St., New York, NY, 10016, US

(21) Appl. No.: 11/114,763

(22) Filed: Apr. 27, 2005

Related U.S. Application Data
(63) Continuation-in-part of application No. 11/074,236, filed on Mar. 7, 2005.
(63) Continuation-in-part of application No. 11/059,088, filed on Feb. 16, 2005.

(51) Int. Cl. G10L 15/26; H04M 11/00

(52) U.S. Cl. 704/235; 379/93.15

(57) ABSTRACT

A system for influencing health-care utilizations by patients and physicians comprises a plurality of templates of first digital text data on health and health-care related information on and relating to patients and health-care related information relating to physicians. The digital audio data comprising health and health-care related information on and relating to patients, the products of physicians' articulations of the information, are sent and transmitted to a centralized system or systems of computers. The computers provide processes for manipulating the digital audio data to optimize the fidelity, for transforming the digital audio data into digital text data, for correcting digital text data, and for appropriately placing the data into the templates.

This is application is a continuation-in-part of application Ser. No. 11/074,236 entitled the System of Management of Health-care Resources filed Mar. 7, 2005 and Ser. No. 11/059,088 entitled the Consumers-Buyers-Physicians Health-care filed Feb. 16, 2005 which are pending.

### FIELD OF INVENTION

Physicians' means for guiding the utilizations health-care resources.

### BACKGROUND OF THE INVENTION

A pending application Ser. No. 11/074,236 entitled the System of Management of Health-care Resources filed Mar. 7, 2005, a pending application Ser. No. 11/059,088 entitled the Consumers-Buyers-Physicians Health-care filed Feb. 16, 2005, a pending application Ser. No. 11/022,410 filed Dec. 27, 2004 entitled the Consumers-Buyers-Physicians Health-care, a pending application Ser. No. 10/950,315 entitled a Method of Empowering Consumers-Controlled Health-Care filed Sep. 27, 2004, a pending application Ser. No. 10/760,694 entitled a method of Modulating Health-Care expenses filed Jan. 21, 2004, a pending application Ser. No. 10/328,993 entitled the Best American Healthcare System filed Dec. 26, 2002, and an abandoned application Ser. No. 10/298,100 entitled the Best Healthcare System filed Nov. 18, 2002 and Patent 6,132,218 entitled Images for Communication of Medical Information in Computer was granted to this applicant on Oct. 17, 2000 represent our continual quests to solve the current health-care crisis.

No prior art has the know-how or the means for solving the current American health-care crisis. However, only said patent applications teach the only means for solving the current American health-care crisis and provide the best, most efficient and cost-effective health-care system. Furthermore, the present invention applies to all physicians in America and world.

The present invention provides all physicians' means for influencing the utilizations of health-care and health-care resources by physicians and patients all over America.

The present invention gives the direct and unencumbered interactions between physicians and patients without the interferences of the third parties and the like.

Specifically, the present invention provides all physicians' best means for controlling and, therefore, curbing the costs relating to the utilizations of health-care and health-care resources by people including physicians.

More specifically, the present invention endows all physicians the utmost freedom to exercise their right, medical ethics and power to directly, most efficiently, expeditiously and ethically deliver the best, most efficient and cost-effective health-care system.

### SUMMARY OF THE INVENTION

No prior art has the know-how or the means for solving the current health-care crisis. The current American health-care crisis can be solved only by and the best health-care system can only be had with the system provides by said pending applications in particular the present invention described herein.

The present invention is a system for influencing, controlling, monitoring and guiding health-care utilizations by patients and physicians comprises a plurality of templates of first digital text data on health and health-care related information on and relating to patients and health-care related information relating to physicians. The digital audio data comprising health and health-care related information on and relating to patients—the products of physicians' articulations of said information—are sent and transmitted to a centralized system or a plurality of centralized systems of computers. Said system or systems provides or provide processes and means for manipulating the digital audio data to optimize their fidelity, for transforming the digital audio data into digital text data, for correcting digital text data, and for appropriately placing said digital text data into said templates which are viewed by physicians and patients to fulfill the objectives of the present invention.

### DESCRIPTION OF THE PREFERRED EMBODIMENTS

The present invention provides a system and method for influencing, controlling, monitoring and guiding the utilizations of health-care resources by patients and physicians and the dispensations of health-care by physicians.

The present invention provides a system of templates comprise first digital text data on health and health-care related information on and related to patients who use and consume health-care resources. Furthermore, said first digital text data in said system of templates also comprise health-care related information or data relating to the utilizations and dispensations of health-care and health-care resources to patients by physicians of diverse specialities and expertises who are in diverse and different settings, premises and localities in America or the world.

Said templates can be viewed by patients and physicians who are in diverse and different settings, premises and localities in America or the world to achieve the objectives of the present invention. Said system is to be used by as many physicians as there are in diverse settings, premises and localities in America and all over the world.

According to this applicant's teaching in earlier patent applications, said physicians' voice outputs comprising patients' health information or data representing said physicians' thought processes on said information or data are converted to digital audio data. The digital audio data is sent and transmitted as digital audio data by wireless and/or cable means for sending and transmitting data to a centralized system or a plurality of centralized systems of computer means for manipulating and transforming said digital audio data into second digital text data. The digital audio data are transmitted and stored in one or numerous audio file formats such as, but not limited to, lossless formats such as WAV (or WAVEform audio format), PCM, TTA, FLAC and AU or lossy compression formats such as MP3, Ogg Vorbis, Windows Media Audio, AAC. Said centralized system or said plurality of centralized systems of computer means can be located in one locality or a plurality of premises and localities, respectively, throughout America.

Physicians with diverse ethnic and language backgrounds and in diverse and different settings, premises and localities output diverse acoustics and sound qualities and intensities, the present invention provides a process for optimizing the fidelity of the digital audio data by a process of using a means for manipulating said digital audio data in said centralized system or systems of computer means so that corrections and compensations for said diversity and variations can be achieved. Furthermore, the present invention provides a process for transforming said digital audio data into second digital text data wherein a means for transforming said digital audio data into digital text data is used. The present invention further provides a process of maximizing the accuracy of said information or data and a use of a means for manipulating said second digital text data in said centralized system of computer means to maximize the accuracy of said information or data.

The present invention further provides a process of computer-automatically placing or inserting said second digital text data into said templates of first digital text data in said centralized system or systems of computer means and processes and a means for placing or inserting said digital text data into said templates.

The demographic information on individual physicians are used as an aid for said process of placing or inserting said second digital text data into said templates according to the relationship of said second digital text data to said first digital text data of said templates, and vice versa. The present invention provides a process of using demographic information on individual physicians for aiding said placing of said digital text data into said templates. The demographic information comprises unique identifications of individual physicians' selected, happened, biological, or assigned unique identities such as, but not limited to, a physician's names, date of birth, social security, gender, tax number or numbers, DNA codes, finger prints and pattern of retina or voice and health data.

Moreover, said physicians and patients in diverse settings, premises and localities perpetually create and add said digital text data especially the digital text data being derived from digital audio data being produced by said physicians. The computer-automated additions or insertions of specific portions of said digital text data into appropriate and correspondingly appropriate portions in said templates are achieved by processes and means described herein.

Said expanding and ubiquitous templates are viewed by said patients and physicians under appropriate circumstances in diverse and different settings, premises and localities in America or the world.

Furthermore, the present invention applies to all physicians in America and world. It is also understood that physicians and patients also encompass dentists, vetanarians and animals.

Although various preferred embodiments of this invention have been described, it will be appreciated by those skilled in the art that adaptations and variations may be made without departing from the spirit of the invention and the scope of the claims.

1. A system of illustrating health and health-care related information on and relating to patients and health-care related information relating to physicians for influencing health-care utilizations by patients and physicians comprising a plurality of templates of first digital text data on and relating to said information into which are placed or inserted second digital text data on health and health-care related information on and relating to patients by a computer means for placing or inserting said second digital text data into said templates wherein patient's or patients' health and health-care related information being derived from physicians' voice outputs as the products of physicians' articulation of the thought processes on said information or data by said physicians situated in diverse settings and premises, wherein said outputs are transformed into and transmitted as digital audio data to a centralized system or a plurality of centralized systems of computer means for manipulating and transforming said digital audio data into second digital text data and a centralized system or a plurality of centralized systems of computer means for placing or inserting said second digital text data into said templates and wherein said second digital text data are computer-automatically placed or inserted into said templates by a computer means for placing or inserting said second digital text data into said templates comprises:
a computer means for manipulating said digital audio data;
a computer means for transforming said digital audio data into second digital text data;
a computer means for placing second digital text data into said templates;
a process of sending digital audio data comprising a patient's health information to a computer means for manipulating said digital audio data;
a process of sending digital audio data comprising a patient's health information to a computer means for transforming said digital audio data into second digital text data;
a process of sending digital audio data comprising a patient's health information to a computer means for placing second digital text data into said templates;
a process of transmitting digital audio data comprising a patient's health information to a computer means for manipulating said digital audio data;
a process of transmitting digital audio data comprising a patient's health information to a computer means for transforming said digital audio data into second digital text data;
a process of transmitting digital audio data comprising a patient's health information to a computer means for placing second digital text data into said templates;
a process of sending digital audio data comprising patients' health information to a computer means for manipulating said digital audio data;
a process of sending digital audio data comprising patients' health information to a computer means for transforming said digital audio data into second digital text data;
a process of sending digital audio data comprising patients' health information to a computer means for placing second digital text data into said templates;
a process of transmitting digital audio data comprising patients' health information to a computer means for manipulating said digital audio data;
a process of transmitting digital audio data comprising patients' health information to a computer means for transforming said digital audio data into second digital text data;
a process of transmitting digital audio data comprising patients' health information to a computer means for placing second digital text data into said templates;
a process of sending digital audio data comprising a patient's health-care related information to a computer means for manipulating said digital audio data;
a process of sending digital audio data comprising a patient's health-care related information to a computer means for transforming said digital audio data into second digital text data;
a process of sending digital audio data comprising a patient's health-care related information to a computer means for placing second digital text data into said templates;
a process of transmitting digital audio data comprising a patient's health-care related information to a computer means for manipulating said digital audio data;
a process of transmitting digital audio data comprising a patient's health-care related information to a computer means for transforming said digital audio data into second digital text data;
a process of transmitting digital audio data comprising a patient's health-care related information to a computer means for placing second digital text data into said templates;
a process of sending digital audio data comprising patients' health-care related information to a computer means for manipulating said digital audio data;
a process of sending digital audio data comprising patients' health-care related information to a computer means for transforming said digital audio data into second digital text data;
a process of sending digital audio data comprising patients' health-care related information to a computer means for placing second digital text data into said templates;
a process of transmitting digital audio data comprising patients' health-care related information to a computer means for manipulating said digital audio data;
a process of transmitting digital audio data comprising patients' health-care related information to a computer means for transforming said digital audio data into second digital text data;
a process of transmitting digital audio data comprising patients' health-care related information to a computer means for placing second digital text data into said templates;
a means for manipulating said digital audio data;
a means for transforming said digital audio data into digital text data;
a means for placing said digital text data into said templates;
a process of manipulating said digital audio data;
a process of converting said digital audio data into said digital text data;
a process of manipulating said digital text data;
a process of using a means for manipulating said digital text data;
a process of placing said digital text data into said templates; demographic information on individual physicians; and
a process of using demographic information on individual physicians for aiding the placing of said digital text data into said templates.

2. The demographic information according to claim 1 comprises unique identifications of individual physicians.

3. A system for monitoring health-care utilizations by patients and physicians comprising a plurality of templates of first digital text data on health and health-care related information on and relating to patients and health-care related information relating to physicians into which are placed or inserted second digital text data on health and health-care related information on and relating to patients by a computer means for placing or inserting said second digital text data into said templates wherein patient's or patients' health and health-care related information or data being derived from physicians' voice outputs as the products of said physicians' articulation of the thought processes on said information or data by said physicians from diverse settings and premises wherein said outputs are transformed into and transmitted as digital audio data to a centralized system or a plurality of centralized systems of computer means for manipulating and transforming said digital audio data into second digital text data and a centralized system or a plurality of centralized systems of computer means for placing or inserting said second digital text data into said templates and comprises:
a plurality of said templates of digital text data;
a computer means for manipulating said digital audio data;
a computer means for transforming said digital audio data into second digital text data;
a computer means for placing second digital text data into said templates;
a process of sending digital audio data comprising a patient's health information to a computer means for manipulating said digital audio data;
a process of sending digital audio data comprising a patient's health information to a computer means for transforming said digital audio data into second digital text data;
a process of sending digital audio data comprising a patient's health information to a computer means for placing second digital text data into said templates;
a process of transmitting digital audio data comprising a patient's health information to a computer means for manipulating said digital audio data;
a process of transmitting digital audio data comprising a patient's health information to a computer means for transforming said digital audio data into second digital text data;
a process of transmitting digital audio data comprising a patient's health information to a computer means for placing second digital text data into said templates;
a process of sending digital audio data comprising patients' health information to a computer means for manipulating said digital audio data;
a process of sending digital audio data comprising patients' health information to a computer means for transforming said digital audio data into second digital text data;
a process of sending digital audio data comprising patients' health information to a computer means for placing second digital text data into said templates;
a process of transmitting digital audio data comprising patients' health information to a computer means for manipulating said digital audio data;
a process of transmitting digital audio data comprising patients' health information to a computer means for transforming said digital audio data into second digital text data;
a process of transmitting digital audio data comprising patients' health information to a computer means for placing second digital text data into said templates;
a process of sending digital audio data comprising a patient's health-care related information to a computer means for manipulating said digital audio data;
a process of sending digital audio data comprising a patient's health-care related information to a computer means for transforming said digital audio data into second digital text data;
a process of sending digital audio data comprising a patient's health-care related information to a computer means for placing second digital text data into said templates;
a process of transmitting digital audio data comprising a patient's health-care related information to a computer means for manipulating said digital audio data;
a process of transmitting digital audio data comprising a patient's health-care related information to a computer means for transforming said digital audio data into second digital text data;
a process of transmitting digital audio data comprising a patient's health-care related information to a computer means for placing second digital text data into said templates;
a process of sending digital audio data comprising patients' health-care related information to a computer means for manipulating said digital audio data;
a process of sending digital audio data comprising patients' health-care related information to a computer means for transforming said digital audio data into second digital text data;
a process of sending digital audio data comprising patients' health-care related information to a computer means for placing second digital text data into said templates;
a process of transmitting digital audio data comprising patients' health-care related information to a computer means for manipulating said digital audio data;
a process of transmitting digital audio data comprising patients' health-care related information to a computer means for transforming said digital audio data into second digital text data;
a process of transmitting digital audio data comprising patients' health-care related information to a computer means for placing second digital text data into said templates;
a means for manipulating said digital audio data;
a means for transforming said digital audio data into digital text data;
a means for placing said digital text data into said templates;
a process of manipulating said digital audio data;
a process of converting said digital audio data into said digital text data;
a process of manipulating said digital text data;
a process of using a means for manipulating said digital text data;
a process of placing said digital text data into said templates;
demographic information on individual physicians; and
a process of using demographic information on individual physicians for aiding in the placing said digital text data into said templates.

4. A method of showing a plurality of templates comprising first digital text data on health and health-care related information on and relating to patients and health-care related information relating to physicians, of manipulating digital audio data on patients' health and health-care related information, of transforming said digital audio data into digital text data, of placing or inserting said digital text data into said templates by an computerized automatic process of placing or inserting digital text data for influencing health-care utilizations by patients and physicians wherein said digital audio data are derived from physicians' voice outputs as the products of said physicians' articulation of the thought processes on said information or data by said physicians situated in diverse settings, premises and localities and wherein said outputs are transformed into digital audio data which are transmitted to a centralized system or a plurality of centralized systems of computer means for manipulating and transforming said digital audio data into second digital text data and a centralized system or a plurality of centralized systems of computer means for placing said second digital text data into said templates comprises:
a process of illustrating said plurality of templates of digital text data;
a process of sending digital audio data comprising a patient's health information to a computer means for manipulating said digital audio data;
a process of sending digital audio data comprising a patient's health information to a computer means for transforming said digital audio data into second digital text data;
a process of sending digital audio data comprising a patient's health information to a computer means for placing second digital text data into said templates;
a process of transmitting digital audio data comprising a patient's health information to a computer means for manipulating said digital audio data;
a process of transmitting digital audio data comprising a patient's health information to a computer means for transforming said digital audio data into second digital text data;
a process of transmitting digital audio data comprising a patient's health information to a computer means for placing second digital text data into said templates;
a process of sending digital audio data comprising patients' health information to a computer means for manipulating said digital audio data;
a process of sending digital audio data comprising patients' health information to a computer means for transforming said digital audio data into second digital text data;
a process of sending digital audio data comprising patients' health information to a computer means for placing second digital text data into said templates;
a process of transmitting digital audio data comprising patients' health information to a computer means for manipulating said digital audio data;
a process of transmitting digital audio data comprising patients' health information to a computer means for transforming said digital audio data into second digital text data;
a process of transmitting digital audio data comprising patients' health information to a computer means for placing second digital text data into said templates;
a process of sending digital audio data comprising a patient's health-care related information to a computer means for manipulating said digital audio data;
a process of sending digital audio data comprising a patient's health-care related information to a computer means for transforming said digital audio data into second digital text data;
a process of sending digital audio data comprising a patient's health-care related information to a computer means for placing second digital text data into said templates;
a process of transmitting digital audio data comprising a patient's health-care related information to a computer means for manipulating said digital audio data;
a process of transmitting digital audio data comprising a patient's health-care related information to a computer means for transforming said digital audio data into second digital text data;
a process of transmitting digital audio data comprising a patient's health-care related information to a computer means for placing second digital text data into said templates;
a process of sending digital audio data comprising patients' health-care related information to a computer means for manipulating said digital audio data;
a process of sending digital audio data comprising patients' health-care related information to a computer means for transforming said digital audio data into second digital text data;
a process of sending digital audio data comprising patients' health-care related information to a computer means for placing second digital text data into said templates;
a process of transmitting digital audio data comprising patients' health-care related information to a computer means for manipulating said digital audio data;
a process of transmitting digital audio data comprising patients' health-care related information to a computer means for transforming said digital audio data into second digital text data;
a process of transmitting digital audio data comprising patients' health-care related information to a computer means for placing second digital text data into said templates;
a process of manipulating said digital audio data;
a process of using a means for manipulating said digital audio data;
a process of transforming said digital audio data into digital text data;
a process of manipulating said digital text data;
a process of using a means for manipulating said digital text data;
a process of using a means for transforming said digital audio data into digital text data;
a process of placing digital text data into said templates;
a process of using a means for placing said digital text data into said templates;
a process of using demographic information on individual physicians for aiding in the placing said digital text data into said templates.
